(19) United States
(12) Patent Application Publication
(10) Pub. No.: US 2009/0083694 A1
(43) Pub. Date: Mar. 26, 2009

(54) Systems, Methods, and Computer Readable Storage Media for Session Planning

(76) Inventor: Lauren Argott, Lawrenceville, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/860,243

(22) Filed: Sep. 24, 2007

(51) Int. Cl. G06F 9/44; G06F 9/46

(52) U.S. Cl. 717/101; 705/8; 705/9

(57) ABSTRACT

Systems, methods, and computer readable storage media for session planning are provided. Session requirements and timing information corresponding to a group of sessions are received. A determination is made based on the session requirements and the timing information whether the group of sessions is capable of being implemented. If the group of sessions is capable of being implemented, then a session schedule is provided. If the group of sessions is not capable of being implemented, then a notification that the group of sessions is not capable of being implemented is provided.

### TECHNICAL FIELD

This application relates generally to the field of scheduling. More specifically, this application relates to systems, methods, and computer readable storage media for session planning.

### BACKGROUND

Joint application design (JAD) is a management process which allows corporate information services departments to work more effectively with other corporate departments in developing software applications. Since the late 1970s, JAD has proven to be an effective technique for building commitment to the success of application development through active participation in the analysis of application requirements and specifications.

JAD sessions bring stakeholders and systems professionals together to resolve their differences in a neutral, non-hostile atmosphere. A key to the session is a specially trained, unbiased facilitator who is not a member of the project team and therefore has no political stake in the outcome of the session. A JAD session may have a structured agenda with clear objectives including a mechanism for resolving open issues that often hinder the design process. The goals may be clearly defined during pre-session activities so that there can be a smooth and successful transition to the next phase in the application design.

JAD sessions are effective at various levels: enterprise, business area, application, and implementation project management. Facilitated sessions can be used whenever a group of diverse individuals needs to reach a workable consensus. Today, sessions are commonly used for strategic business planning, strategic information services (IS) planning, IS architecture definition, re-engineering business processes, detailed system design, process and data modeling, and project management. Coordinating and planning JAD sessions can be very time consuming since it requires determining dates and times for the JAD sessions, determining who is to be invited to the JAS sessions, and ensuring that those who are invited to the JAD sessions attend such sessions.

### SUMMARY

Systems, methods, and computer readable storage media for session planning are provided. Embodiments provided herein include receiving session requirements and timing information corresponding to a group of sessions. A determination is made based on the session requirements and the timing information whether the group of sessions is capable of being implemented. If the group of sessions is capable of being implemented, then a session schedule is provided. If the group of sessions is not capable of being implemented, then a notification that the group of sessions is not capable of being implemented is provided.

Other systems, methods, and/or computer readable storage media according to embodiments will be or become apparent to one with skill in the art upon review of the following drawings and detailed description. It is intended that all such additional systems, methods, and/or computer readable storage media be included within this description, be within the scope of the present invention, and be protected by the accompanying claims.

### BRIEF DESCRIPTION OF THE DRAWINGS

FIG. 1-9 are schematic diagrams depicting respective examples of user interface windows, in accordance with embodiments of the disclosure provided herein.

FIG. 10 is a schematic diagram depicting an example of an e-mail window, in accordance with embodiments of the disclosure provided herein.

FIG. 11 is a flow chart flowchart illustrating a method for session planning, in accordance with embodiments of the disclosure provided herein.

FIGS. 12-18 are flow charts collectively illustrating another method for session planning, in accordance with embodiments of the disclosure provided herein.

FIG. 19 is a block diagram depicting a computer used for session planning, in accordance with embodiments of the disclosure provided herein.

### DETAILED DESCRIPTION

The following detailed description is directed to methods, systems, and computer-readable storage media for session planning. In the following detailed description, references are made to the accompanying drawings that form a part hereof, and which are shown by way of exemplary embodiments and implementations. Although embodiments described below are discussed in the context of joint application design (JAD) session planning, a person of ordinary skill in the art would appreciate that principles of the embodiments are applicable to other types of session planning.

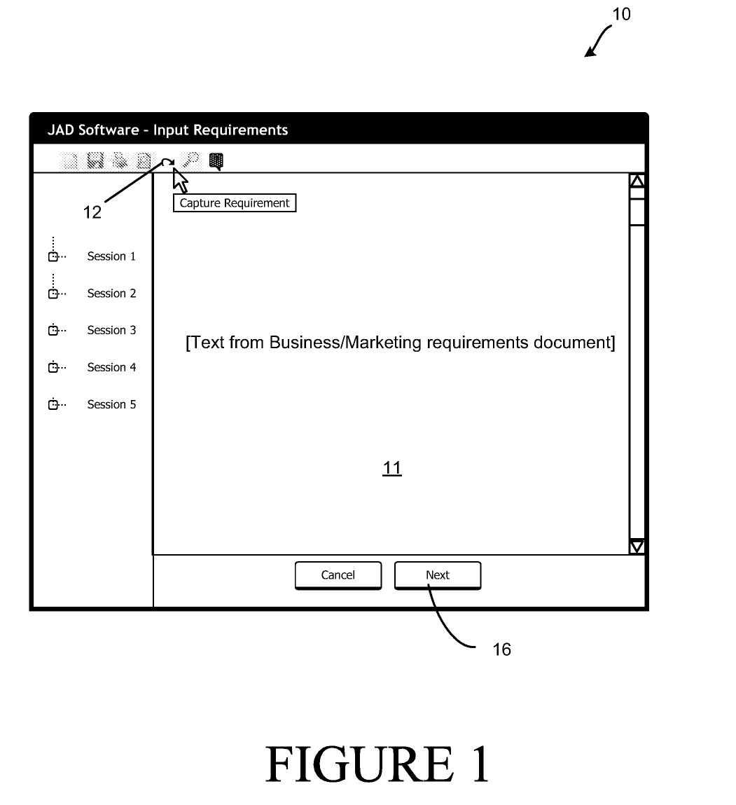

According to embodiments provided herein, a user may initiate JAD planning software to begin planning a group of JAD sessions. FIG. 1 is a schematic diagram depicting an example of a user interface window 10 provided to a user upon initiation of the JAD planning software, in accordance with exemplary embodiments. The user interface window 10 includes a main section 11 that displays text corresponding to business and/or marketing requirements for the software application to be designed using JAD sessions. The business and/or marketing requirement may specify functionality of a software application, where and when the application is to be implemented, and/or who the target users of the application are. The text displayed in the main section 11 may be from a document that is received by the user of the user interface window 10 via, for example, e-mail. The user may select the capture option 12 to request that the JAD planning software analyze the business/marketing requirements to determine information and requirements regarding JAD sessions, such as the number of sessions and their respective topics and durations. The JAD session information may be determined by the JAD planning software based on topic headings, keywords, combinations of keywords, and/or frequency with which keywords are used in the business/marketing requirements information. Alternatively, the JAD session information and requirements maybe input by the user and/or determined based preprogrammed logic. The user may then select the “Next” option 16 to proceed.

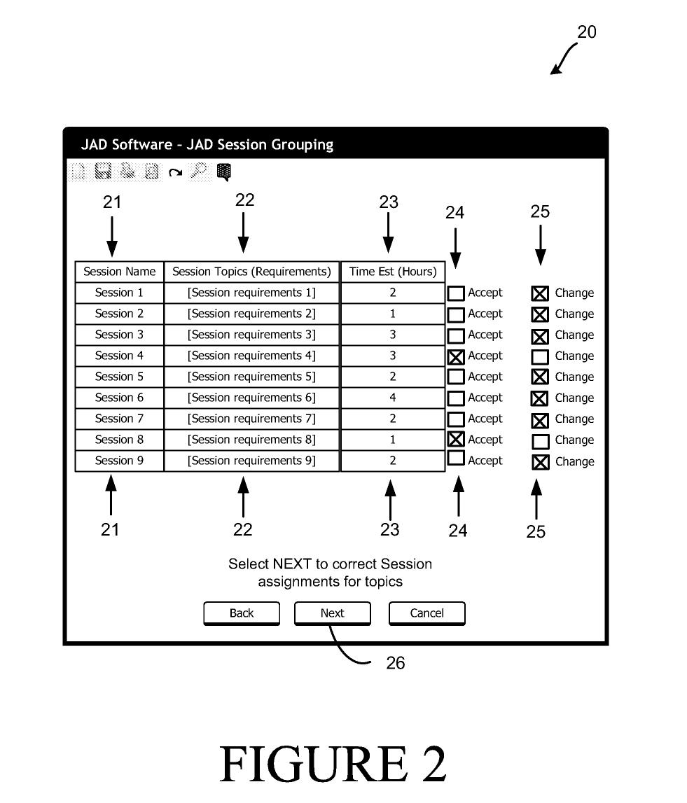

FIG. 2 is a schematic diagram depicting an example of a user interface window 20, in accordance with exemplary embodiments. The user interface window 20 includes a session name column 21, a session topic column 22, and a time column 23. The session name column 21 displays names of JAD sessions, such as session 1, session 2, session 3, session 4, and session 5. The session topic column 22 displays session topics corresponding to the sessions identified in the sessions name column 21. The time column 23 displays estimated durations for the sessions identified in the sessions name column 21. The information in columns 21-23 may be determined by the JAD planning software based on an analysis of the business/marketing requirements or from information and requirements received from the user.

For each session listed in the session name column 21, the user may select an option from the accept column 24 to accept the corresponding topic and time, or an option from the change column 25 to request a change in a corresponding topic and/or time. After the user selects the desirable accept and/or change options from columns 24 and/or 25, the user may then select the “Next” option 26 to proceed.

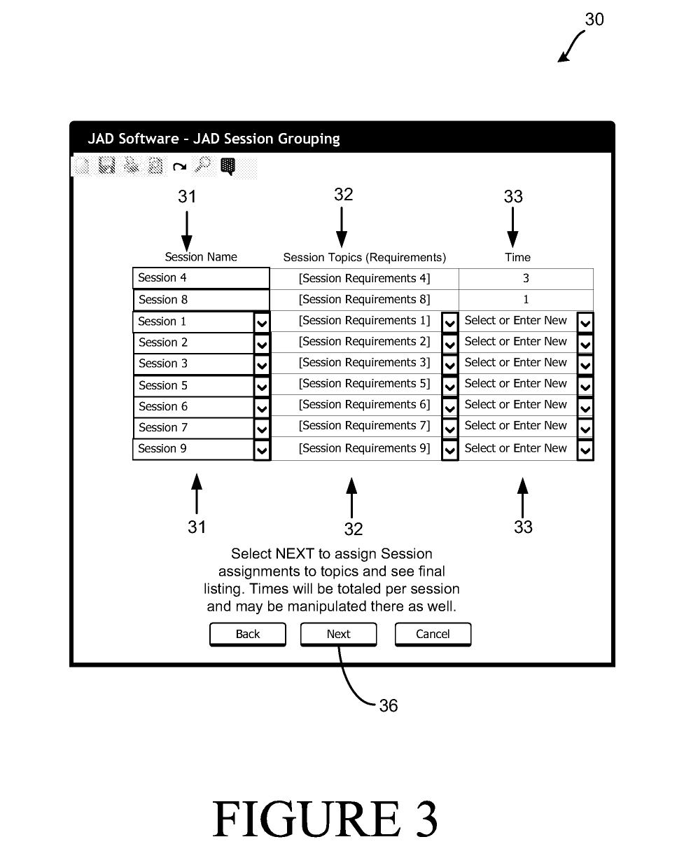

FIG. 3 is a schematic diagram depicting an example of a user interface window 30, in accordance with exemplary embodiments. The user is provided with the user interface window 30 responsive to selecting the “Next” option 26 in the user interface window 20. The user interface window 30 includes a session name column 31, a session topic column 32, and a time column 33 which correspond to the session name column 21, the session topic column 22, and the time column 23. The session name column 31 includes JAD session names, the topic column 32 includes corresponding session topics, and the time column 33 includes session durations. The columns 31-33 enable a user to change session-related information for sessions that the user did not accept via the user interface window 20. The user may enter another session name in the session name column 31 for each session topic listed in the topic column 32. The user may alternatively select a session name from a respective pull-down menu in the session name column 31. The user may also enter or select respective session topics and a session durations via columns 32 and 33 for each session listed in the session name column 31. The user may then select the “Next” option 36 to proceed.

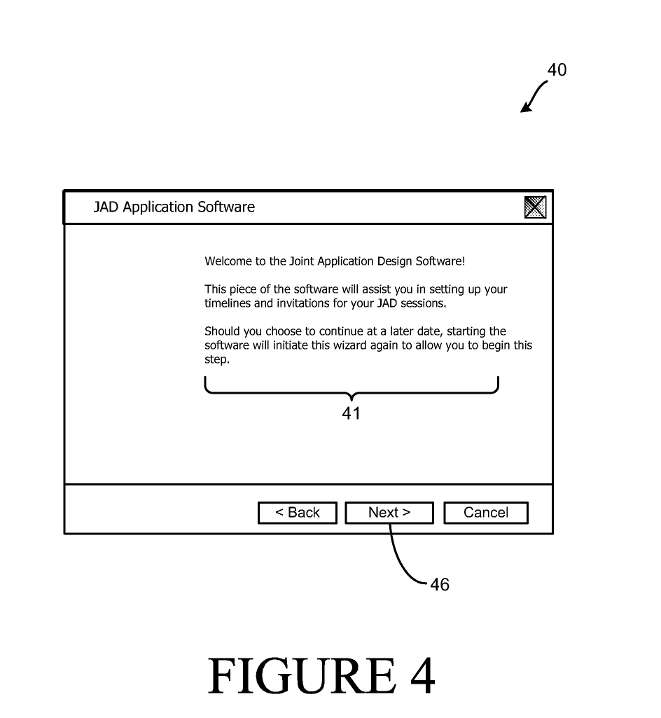

FIG. 4 is a schematic diagram depicting an example of a user interface window 40, in accordance with exemplary embodiments. The user is provided with the user interface window 40 responsive to selecting the “Next” option 36 in the user interface window 30. The user interface window 40 includes an information area 41 that includes general information regarding the JAD planning software. In this example, the information area 41 includes the following text: “Welcome to the Joint Application Design Software! This piece of the software will assist you in setting up your timelines and invitations for your JAD sessions. Should you choose to continue at a later date, starting the software will initiate this wizard again to allow you to begin this step.” The user may then select the “Next” option 46 to proceed. It should be appreciated that different information or instructions may be provided in the user interface window 40, or any other window described herein.

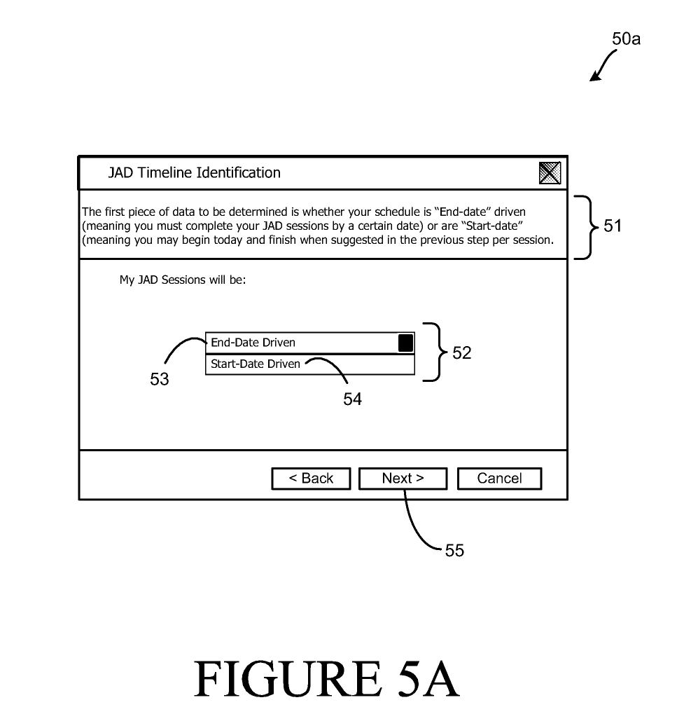

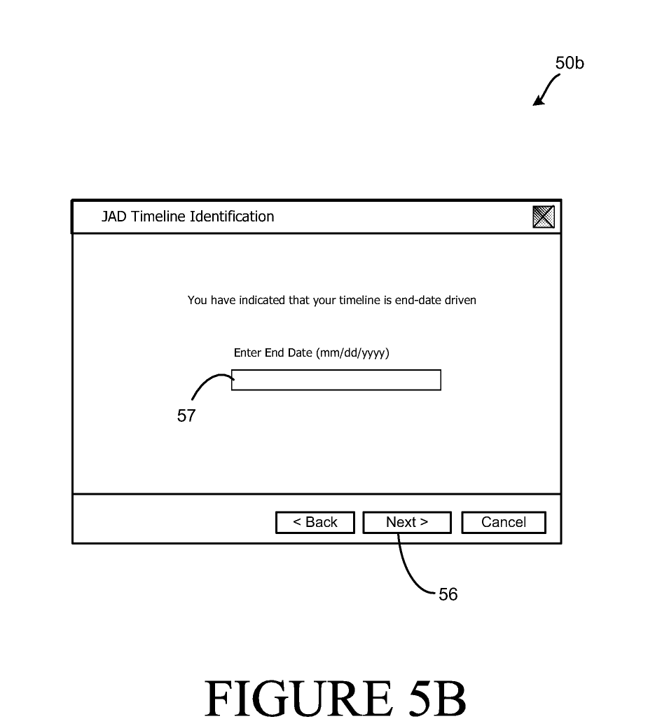

FIG. 5A is a schematic diagram depicting an example of a user interface window 50a, in accordance with exemplary embodiments. The user is provided with the user interface window 50a responsive to selecting the “Next” option 46 in the user interface window 40. The user interface window 50a includes an information area 51 regarding JAD session timelines. In this example the information area 51 includes the following text: “The first piece of data to be determined is whether your schedule is “End-date” driven (meaning you must complete your JAD sessions by a certain date) or are “Start-date” (meaning you may begin today and finish when suggested in the previous block per session).” The user interface window 50a also includes a pull-down menu 52. The user may either select an end-date driven option 53 or a start-date driven option 54 from the pull-down menu 52. The end-date driven option 53 may be selected if the user has a target date for when the JAD sessions are to be completed. The start-date driven option 54 may be selected if the user does not have a target date for when the JAD sessions are to be completed. After selecting either the end-date driven option 53 or the start-date driven option 54, the user may then select the “Next” option 55 to proceed.

FIG. 5B is a schematic diagram depicting an example of a user interface window 50b, in accordance with exemplary embodiments. The user is provided with the user interface window 50b responsive to selecting the “Next” option 55 in the user interface window 50a after selecting option 53 in window 40. The user interface window 50b includes a date entry field 57 for receiving an end-date for the JAD sessions. After the user enters an end-date in the date entry field 57 and selects the “Next” option 56, the JAD planning software assigns dates to the respective JAD sessions. The assigned dates take into account the duration of the JAD sessions and allow a minimum time period prior to the JAD sessions during which the JAD session participants are invited, responses to the invitations are received, and the user investigates non-responses or declining responses. This minimum time period may be pre-programmed into the JAD planning software or may be provided by a user. For example, if the end date for the JAD sessions is October 31st, the JAD planning software may determine that the JAD sessions will require five business days and that the invitation, response, and follow-up period will require, for example, at least two weeks. A user may be able to specify an alternate time requirement for the invitation, response, and follow-up period. Based on this information, the JAD planning software will assign the JAD sessions to respective business days among, for example, the final five business days in October. Furthermore, according to one embodiment, the invitations to the JAD sessions will be sent out no later than a pre-determined period (e.g., two weeks) prior to each respective JAD session.

Note that a window similar to the user interface window 50b may be provided to a user that selects the start-date driven option 54 in the user interface window 50a except that the user would be prompted to enter a start-date for when the JAD planning process is to begin. The JAD planning software would then assign respective dates to the JAD sessions based on the indicated start date, the determined session durations, and the estimated invitation, response, and follow-up period.

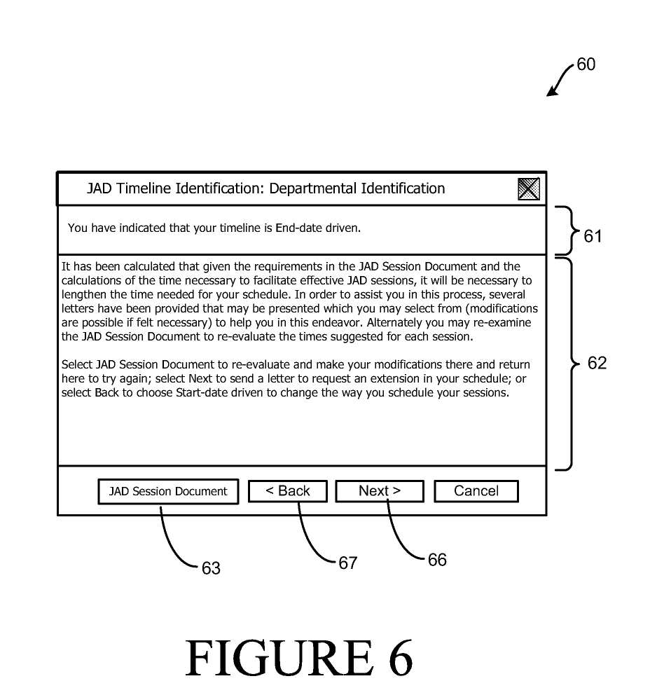

FIG. 6 is a schematic diagram depicting an example of a user interface window 60, in accordance with exemplary embodiments. The user may be provided with the user interface window 60 responsive to selecting the “Next” option 56 in the user interface window 50b if the selected end date conflicts with timelines defined by the JAD. The user interface window 60 includes information areas 61 and 62. The information area 61 provides information confirming the user's timeline selection via window 50a. The information area 62 includes information regarding the options available via window 60.

In this example, the information area 61 includes the following text: “You have indicated that your timeline is end-date driven.” On the other hand, the information area 62 includes the following text: “It has been calculated that given the requirements in the JAD Session Document and the calculations of the time necessary to facilitate effective JAD sessions, it will be necessary to lengthen the time needed for your schedule. In order to assist you in this process, several letters have been provided that may be presented which you may select from (modifications are possible if felt necessary) to help you in this endeavor. Alternately you may re-examine the JAD Session Document to re-evaluate the times suggested for each session. Select JAD Session Document to re-evaluate and make your modifications there and return here to try again; select Next to send a letter to request an extension in your schedule; or select Back to choose Start-date driven to change the way you schedule your sessions.”

To correct a time conflict, the user has several options. First, the user may select a JAD Session Document option 63 to be provided with a JAD session document that the user may modify. Yet, another option is for the user to select the “Next” option 66 to be provided with a letter that can be used to request an extension in the JAD schedule. Alternatively, the user may select the “Back” option 67 to return to the user interface window 50a where the user may, for example, choose the start-date driven option 54.

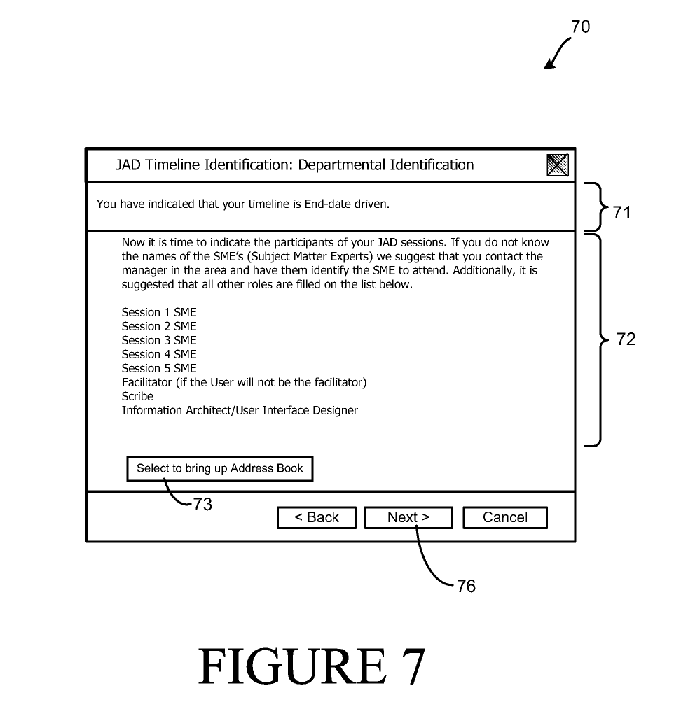

FIG. 7 is a schematic diagram depicting an example of a user interface window 70, in accordance with exemplary embodiments. The user is provided with the user interface window 70 responsive to, for example, selecting the “Next” option 56 in the user interface window 50b. The user interface window 70 includes information areas 71 and 72. The information area 71 confirms that the user has already made a timeline selection. The information area 72 provides the user with information regarding selecting participants for the JAD sessions. The user may select the address book option 73 to view an electronic address book that can be used to retrieve names and e-mail addresses of participants. Alternatively, the user may select the “Next” option 76 to proceed without using an electronic address book.

In this example, the information area 71 includes the following text: “You have indicated that your timeline is Start-date driven (or End-date driven, but with and acceptable end-date).” On the other hand, the information area 72 includes the following text: “Now it is time to indicate the Invitees of your JAD sessions. If you do not know the names of the SME's (Subject Matter Experts) we suggest that you contact the manager in the area and have them identify the SME to attend. Additionally, it is suggested that all other roles are filled on the list below.” The list of participant roles provided in the information area 72 includes: Session 1 SME, Session 2 SME, Session 3 SME, Session 4 SME, Session 5 SME, Facilitator, Scribe, and Information Architect/User Interface Designer.

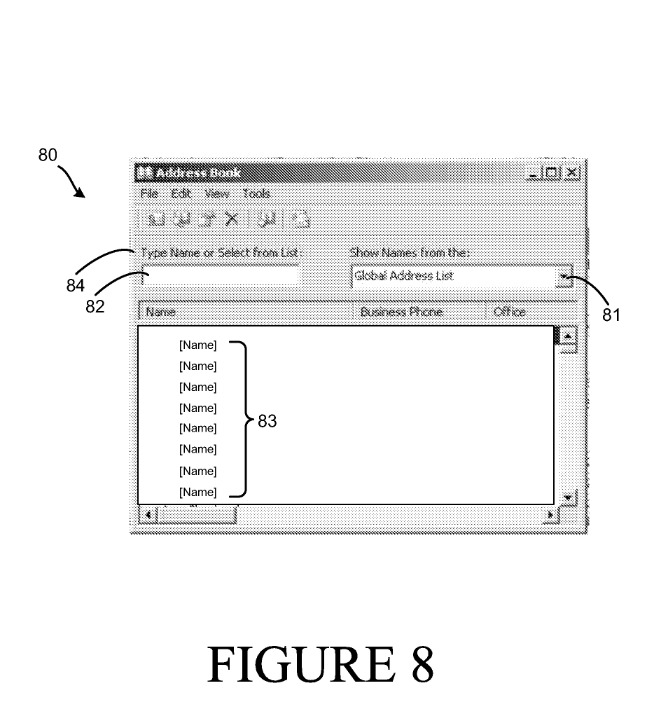

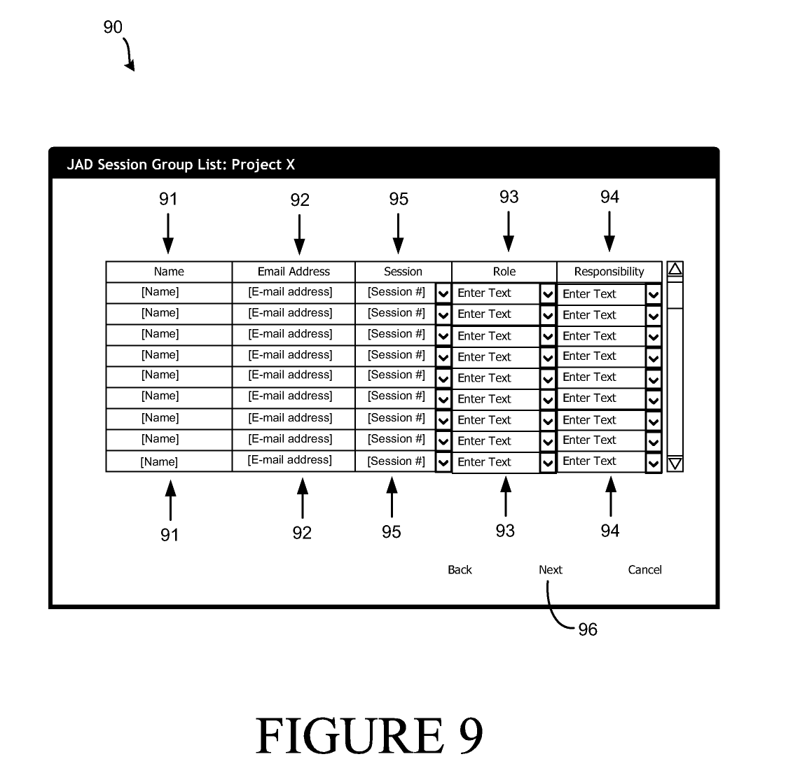

FIG. 8 is a schematic diagram depicting an example of a user interface window 80, in accordance with exemplary embodiments. The user is provided with the user interface window 80 responsive to selecting the address book option 73 in the user interface window 70. The user may be provided with the instruction 84 which states “Type Name or Select from List.” The user may type the name of an participant in entry field 82 to add a name to a list of participants to be contacted by e-mail regarding JAD sessions. Alternatively, the user may select names from a list of names 83. For example, double-clicking on a name via a cursor adds the name to the next available row in the name column 91 (FIG. 9) and causes the cursor to move to a corresponding role cell in the role column 93 (FIG. 9). The address list menu 81 can be used to select an alternative address list having a different list of names. The names selected or entered via the user interface window 80 are shown in the user interface window 90 (FIG. 9) along with corresponding e-mail addresses.

FIG. 9 is a schematic diagram depicting an example of a user interface window 90, in accordance with exemplary embodiments. The user interface window 90 may be, for example, displayed simultaneously with the user interface window 70 and/or the user interface window 80. Alternatively, the user interface window 90 may be displayed separately from the windows 70 and 80. Names selected via the user interface window 80 are displayed in the name column 91. Corresponding e-mail addresses are displayed in the address column 92. The user may enter or select via the session column 95 a JAD session that each participant is to attend. The user may enter or select via the role column 93 a role that each participant is to play in one or more JAD sessions. Examples of roles include: as a facilitator, scribe, recorder, creative services lead (also known as information architect), architectural lead, functionality area lead (also known as SME), marketing lead, and product development lead. The user may enter or select via the responsibility column 94 a corresponding responsibility for each named participant. The selected or entered responsibilities may include, for example, reserving meeting rooms, recording the JAD sessions, and taking notes during the JAD sessions. The user may then select the “Next” option 96 to proceed.

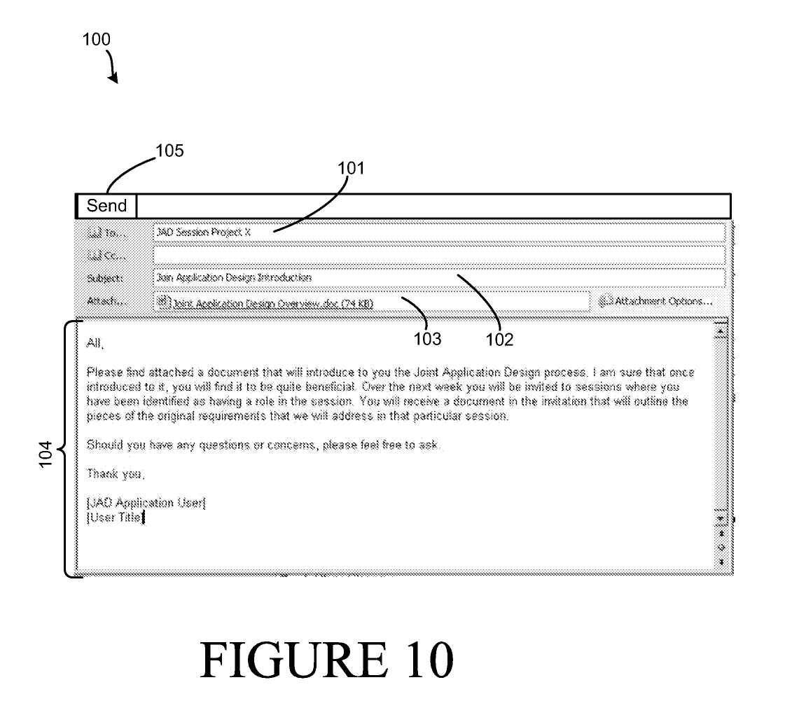

FIG. 10 is a schematic diagram depicting an example of an e-mail window 100, in accordance with exemplary embodiments. The user is provided with the user interface window 100 responsive to selecting the “Next” option 96 in the user interface window 90. The user interface window 100 includes an address field 101, a subject field 102, an attachment field 103, and a message section 104. The address field 101 includes information identifying the intended recipients and/or e-mail addresses that will be receiving the e-mail to be sent via the e-mail window 100. The document identified in the attachment field 103 and that is to be transmitted to the participants includes an overview of the joint application design process. The subject field 102 includes a description of the subject of the message in the message section 104. The user may select the “Send” option 105 to send the e-mail message and corresponding attachment identified in the e-mail window 100 to the participants.

In this example, the message section 104 includes the following text: “All, please find attached a document that will introduce to you a joint application design process. I'm sure that once introduced to it you'll find it to be quite beneficial. Over the next week you'll be invited to sessions where you have been identified as having a role in the session. You will receive a document in the invitation that will outline the pieces of the original requirements that we will address in a particular session. Should you have any questions or concerns, please feel free to ask. Thank you.”

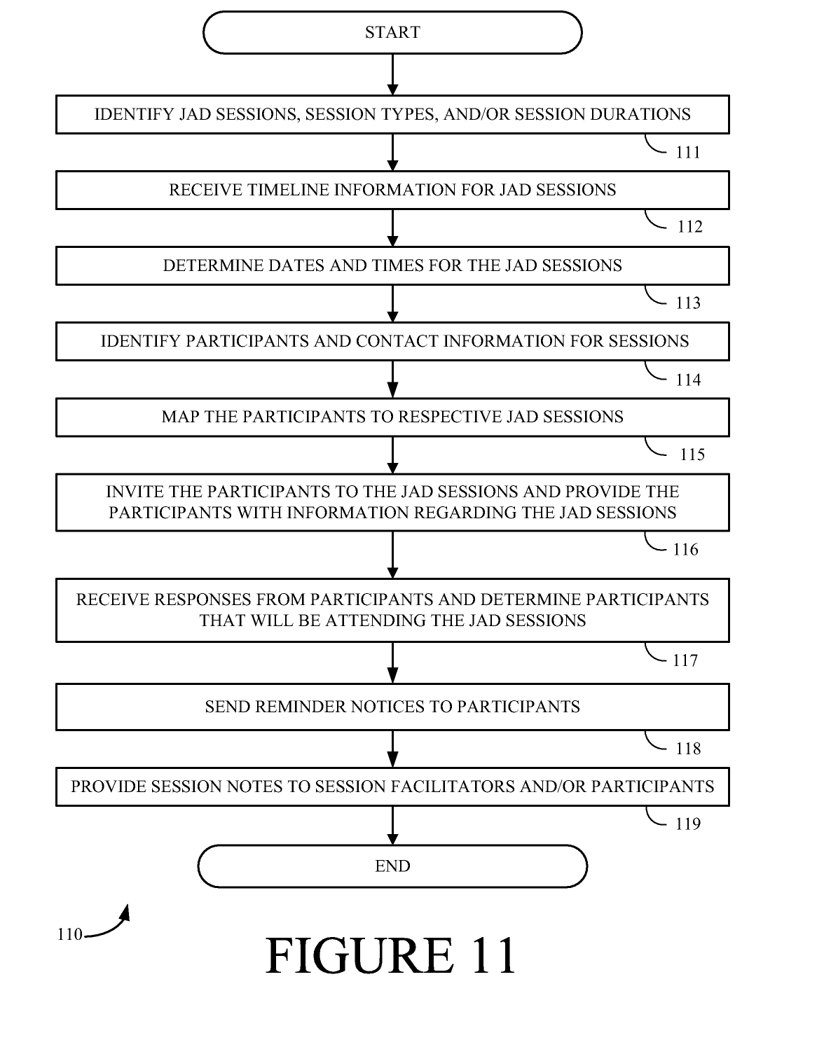

FIG. 11 is a flowchart illustrating a method 110 for session planning, in accordance with exemplary embodiments. As indicated in block 111, the JAD planning software identifies JAD sessions, session types, and/or session durations based on business/marketing requirements information, user input, and/or preprogrammed logic. The step in block 111 may be performed via, for example, user interface windows 10, 20, and 30 described above.

The JAD planning software receives timeline information for JAD sessions, as indicated in block 112. The timeline information identifies whether the JAD schedule will be end-date driven or start-date driven. The timeline information may be provided via, for example, the user interface window 50a. The JAD planning software then determines the dates and times for the JAD sessions, as indicated in block 113. The JAD planning software may determine the dates and times for the JAD sessions based on the determined session durations and the JAD sessions' timeline.

The JAD planning software receives user input identifying participants for JAD sessions as well as their contact information, as indicated in block 114. The participants and their contact information may be identified via for example, the user interface window 80. The JAD planning software maps participants to respective JAD sessions, as indicated in block 115. The mapping of the participants to respective JAD sessions is illustrated, for example, in the user interface window 90.

The JAD planning software invites the participants to the JAD sessions and provides the participants with information regarding the sessions, as indicated in block 116. The JAD session invitations and the JAD session information may be e-mailed to the participants via the JAD planning software or via an e-mail program that is associated with the JAD planning software. The information regarding the JAD sessions may be provided to the participants along with the invitation e-mails or via separate e-mails, depending on a desired implementation.

The JAD planning software receives responses from participants and determines which participants will be attending each JAD session, as indicated in block 117. The responses may be provided responsive to, for example, the participants selecting an “accept” or “decline” option in their respective invitation e-mails. The responses may be automatically forwarded, for example, to the JAD planning software. Invitees may be instructed to provide a reason for declining an invitation to attend a JAD session.

The JAD software may determine who will be attending the JAD sessions based on the responses received from the participants and/or subsequent follow-ups with participants who decline or fail to respond to their invitations. The JAD planning software sends reminder notices to participants regarding corresponding JAD sessions, as indicated in block 118. The reminder notices may be generated via e-mails that are automatically initiated by the JAD planning software at pre-determined times based on the JAD schedule.

After each JAD session, the JAD planning software provides session notes to corresponding JAD session facilitators and/or participants, as indicated in block 119. The JAD planning software may, for example, be configured to e-mail the JAD session notes to the participants after receiving the session notes from a scribe or other JAD session participant.

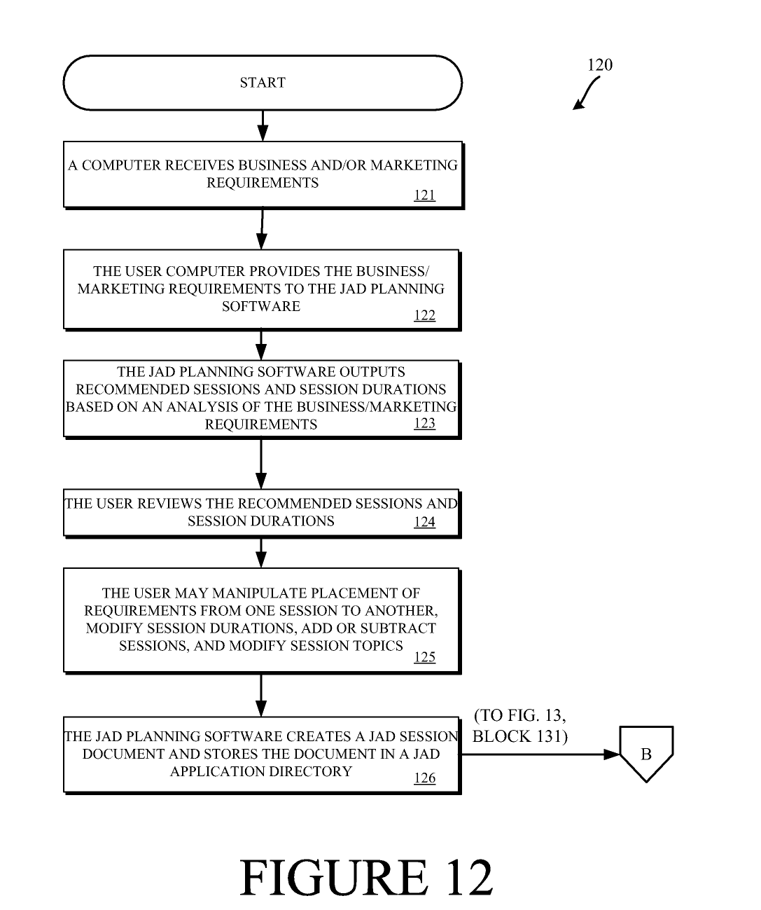

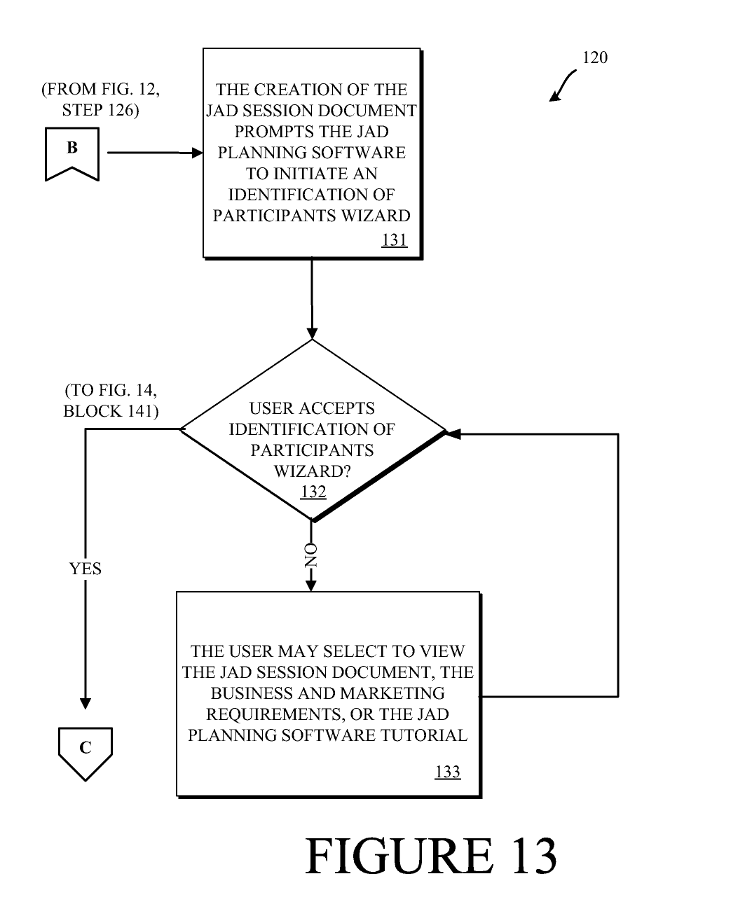

FIGS. 12-18 are flowcharts collectively illustrating another method 120 for session planning, in accordance with exemplary embodiments. With reference to FIG. 12, a computer receives business and/or marketing requirements, as indicated in block 121. The business/marketing requirements may be received, for example, in an electronic document via e-mail. The user computer then provides the business/marketing requirements to the JAD planning software, as indicated in block 122. The JAD planning software may, for example, display the business/marketing requirements via the user interface window 10. The JAD planning software then outputs recommended sessions and session durations based on an analysis of the business/marketing requirements, as indicated in block 123. For example, the JAD planning software may analyze the business/marketing requirements based on specific headings, keywords, and/or keyword combinations to determine the recommended sessions and session durations, as shown, for example, in user interface window 20.

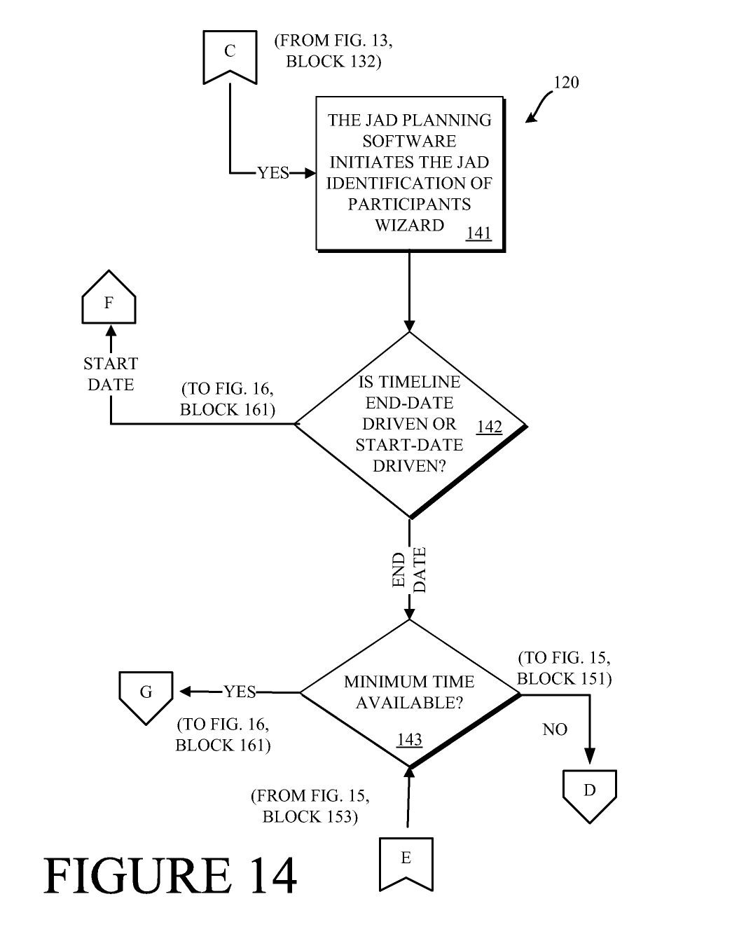

The user then reviews the recommended sessions and session durations, as indicated in block 124. The user may manipulate placement of requirements from one session to another, modify session durations, add or subtract sessions, and modify session topics, as indicated in block 125. The user may edit the session related information via, for example, the user interface window 30. Once the user is satisfied with the session requirements, the JAD planning software creates a JAD session document and stores the document in a JAD application directory, as indicated in block 126. The JAD session document identifies sessions and their respective durations and topics. The method 120 then proceeds to block 131 in FIG. 13.

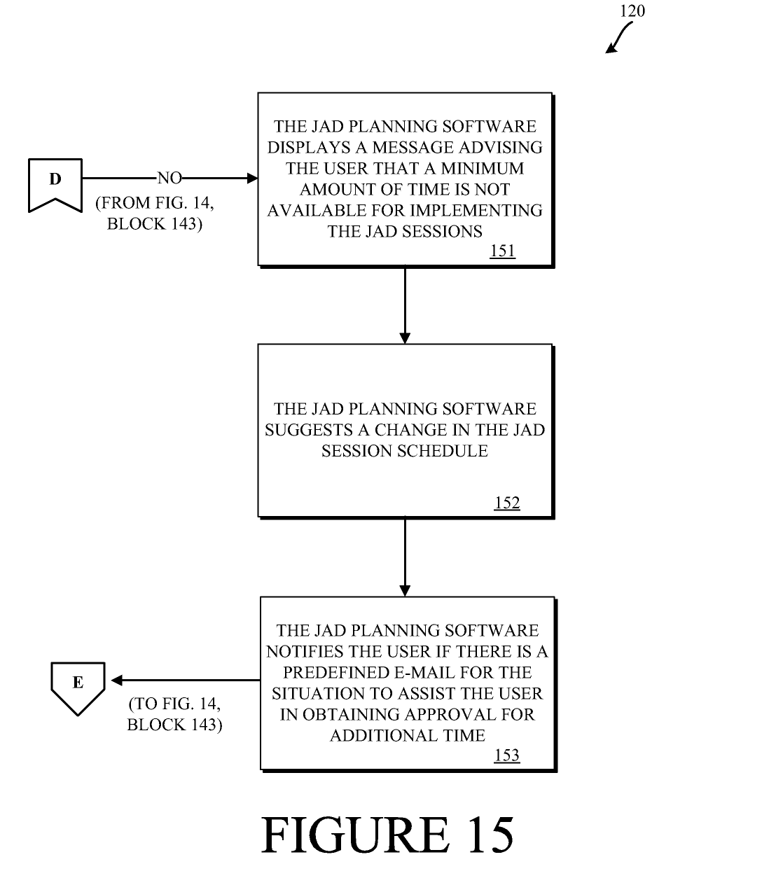

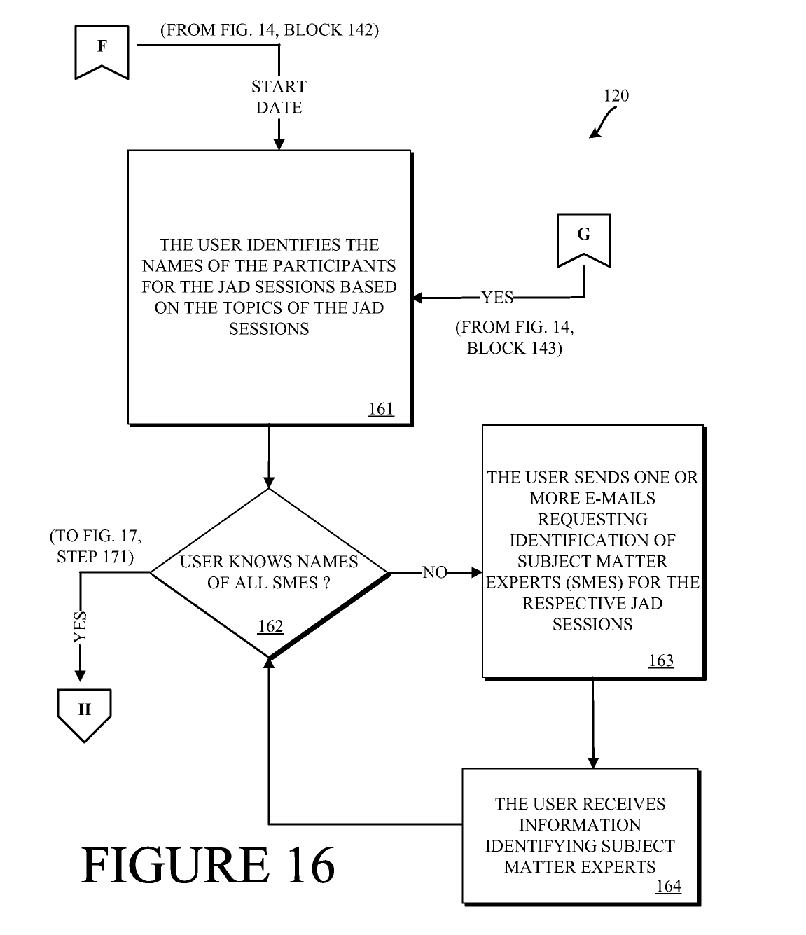

The creation of the JAD session document prompts the JAD planning software to initiate an identification of participants wizard, as indicated in block 131. The JAD planning software then determines whether the user has accepted the identification of participants wizard, as indicated in block 132. If the user does not accept the identification Of Participants Wizard, the user may select to view the JAD session document, the business and marketing requirements, or the JAD planning software tutorial, as indicated in block 133. However, if the user accepts the identification of participants wizard, then the JAD software initiates the JAD identification of participants wizard, as indicated in block 141 of FIG. 14.

The JAD planning software determines whether the timeline is end-date driven or start-date driven, as indicated in block 142. This timeline determination may, for example, be based on user input received via user interface window 50a. If the JAD planning software determines that the timeline is start-date driven, the method 120 proceeds to block 161 in FIG. 16. If the JAD planning software determines that the timeline is end-date driven, the JAD planning software then calculates if a minimum amount of time is available based upon the end-date and upon the number of session and their durations, as indicated in block 143. If the JAD planning software determines that the minimum time is available, the method 120 proceeds to block 161 in FIG. 16. If the JAD planning software determines that the minimum time is not available, then the method 120 proceeds to block 151 in FIG. 15.

As indicated in block 151, the JAD planning software displays a message advising the user that a minimum amount of time is not available for implementing the JAD sessions, and suggests modifications where available. The JAD planning software may, for example, provide the messages displayed in user interface window 60. Where modifications are not available or advisable, the JAD planning software suggests a change in the JAD session schedule if feasible, as indicated in block 152. The JAD planning software notifies the user if there is a predefined e-mail for the situation to assist the user in obtaining approval for additional time, as indicated in block 153. The method 120 then returns to block 143 in FIG. 14.

If the JAD planning software determines that the timeline is start-date driven, or if the JAD planning software determines that the timeline is end-date driven and that there is at least the predetermined minimum amount of time available, then the method 120 proceeds to block 161. As indicated in block 161, the user identifies the names of participants for the JAD sessions based on the topics of the JAD sessions. The user may identify the names of participants via, for example, the user interface window 80.

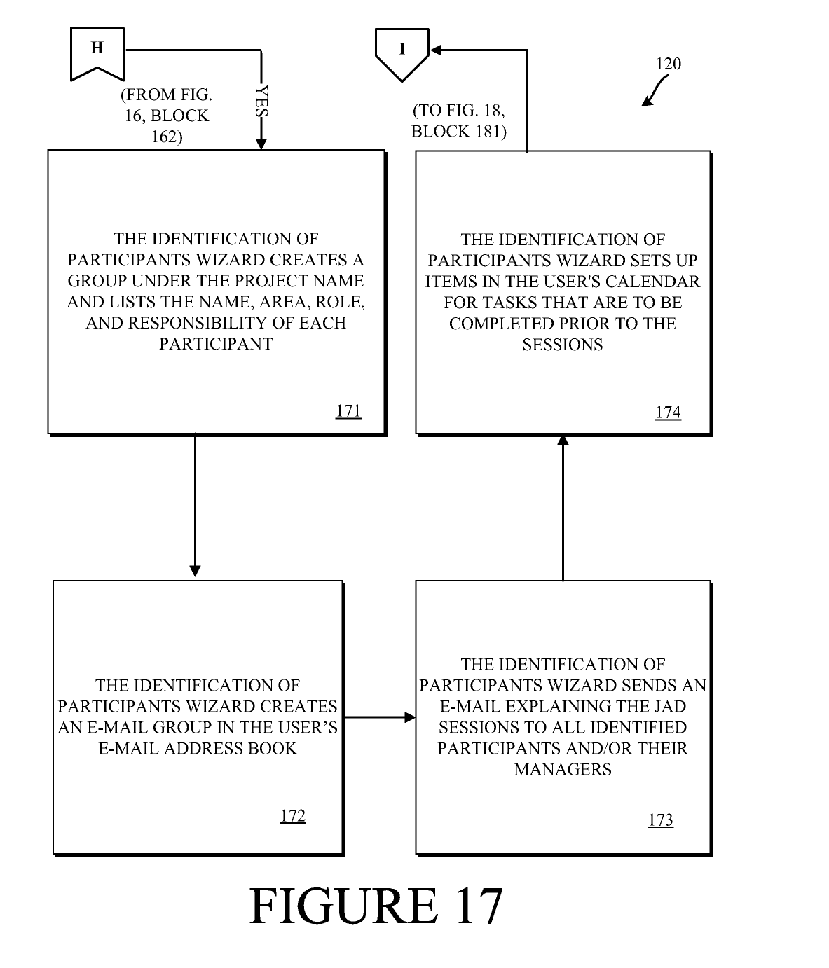

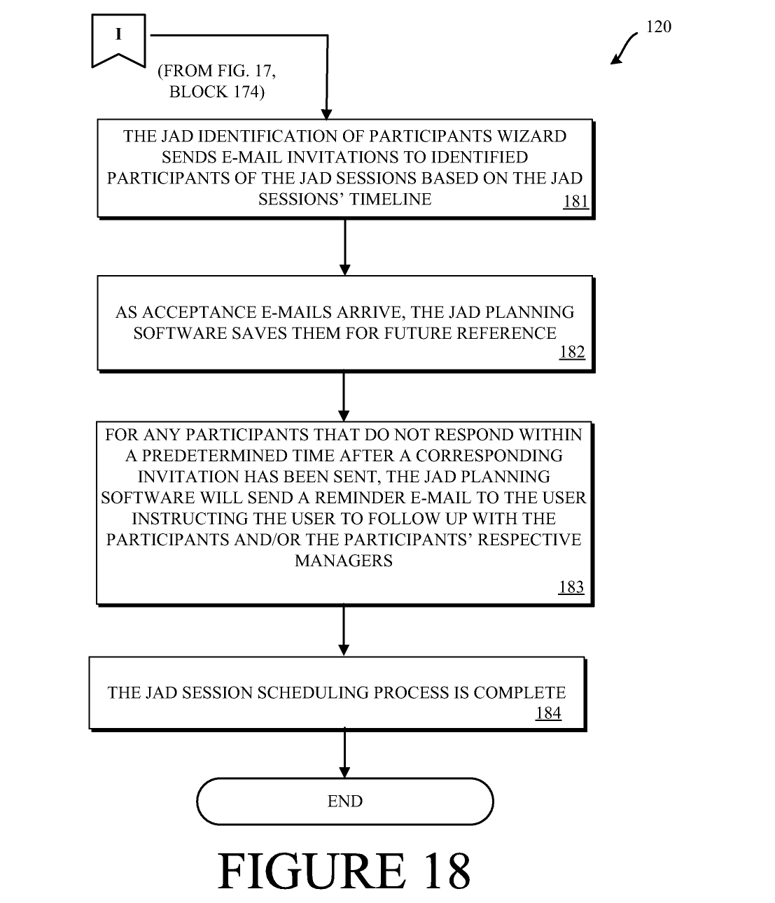

The user then determines whether the user knows the names of all the subject matter experts (SMEs) that are to be invited the JAD sessions, as indicated in block 162. If the user does not know the names of all the subject matter experts to be invited to the JAD sessions, the user sends one or more e-mails requesting identification of subject matter experts for the respective JAD sessions, as indicated in block 163. The user then receives information identifying subject matter experts, as indicated in block 164. If in block 162, the user knows the names of all the subject matter experts to be invited, the method 120 proceeds to block 171 in FIG. 17.

As indicated in block 171, the JAD identification of participants wizard creates a group under the project name and lists the name, area, role, and responsibility of each participant. The contact information for the participants can be pulled directly from the user's address book in the user's default e-mail application. As indicated in block 172, the identification of participants wizard creates an e-mail group in the user's e-mail address book. The identification of participants wizard also creates sub-groups corresponding to respective JAD sessions in order to facilitate the e-mail process. The identification of participants wizard then sends an e-mail message explaining the JAD sessions to all identified participants and/or their managers, as indicated in block 173. The e-mail message may, for example, be similar to the e-mail message displayed in the e-mail window 100.

The identification of participants wizard then sets up items in the user's calendar for tasks that are to be completed prior to the sessions, as indicated in block 174. These steps may include, for example, reserving and/or setting up conference rooms. The method 120 then proceeds to block 181 in FIG. 18.

As indicated in block 181, the JAD identification of participants wizard then sends e-mail invitations to identified participants of the JAD sessions based on the JAD sessions' timeline. As acceptance e-mails arrive, the JAD planning software will save them for future reference, as indicated in block 182. For any participants that do not respond within a predetermined time (e.g., two days) after a corresponding invitation has been sent, the JAD planning software will send a reminder e-mail to the user instructing the user to follow up with the participants and/or the participants' respective managers, as indicated in block 183. The JAD session scheduling process is then complete, as indicated in block 184.

Note that methods depicted in the exemplary flow charts described above may be modified to include fewer, additional, and/or different steps within the scope of this disclosure. Furthermore, steps depicted in the flow charts may be performed out of the order shown including substantially concurrently, in reverse order, or in a substantially different order.

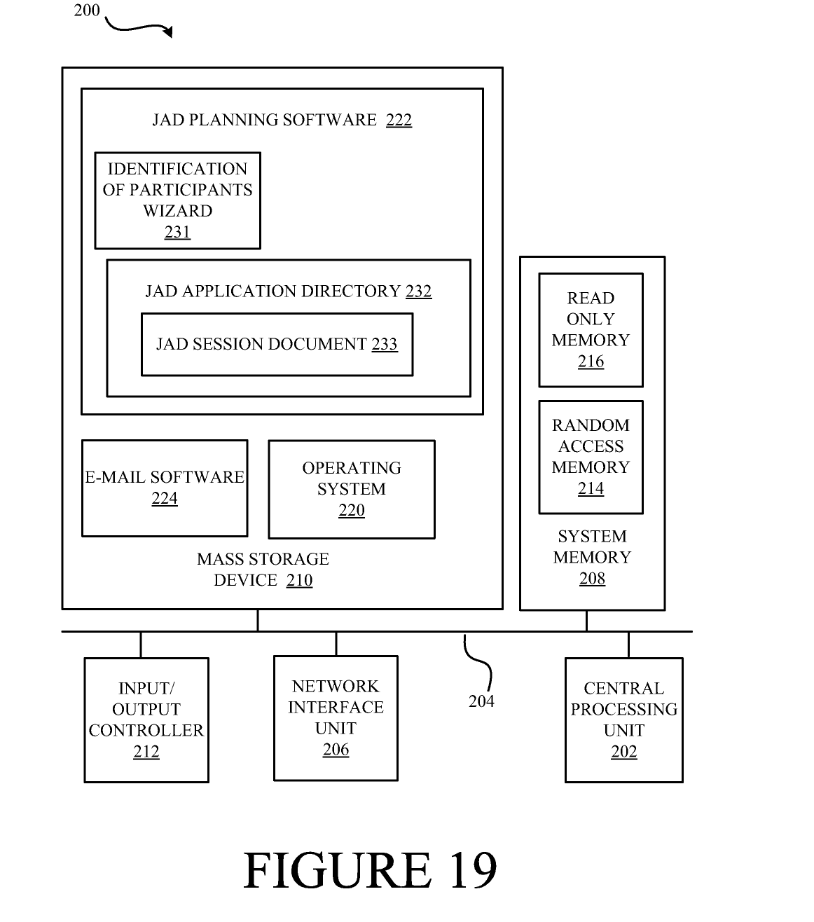

FIG. 19 is a block diagram illustrating a computer 200, operative to perform the operations described herein, in accordance with exemplary embodiments. The computer 200 includes a central processing unit 202 (CPU), a system memory 208, including a random access memory (RAM) 214 and a read-only memory (ROM) 216, and a system bus 204 that couples the memory 208 to the CPU 202. A basic input/output system containing the basic routines that help to transfer information between elements within the computer 200, such as during startup, is stored in the ROM 216. The computer 200 further includes a mass storage device 210 for storing an operating system 220 and other program modules, which will be described in greater detail below.

The mass storage device 210 is connected to the CPU 202 through a mass storage controller (not shown) connected to the bus 204. The mass storage device 210 and its associated computer-readable media provide non-volatile storage for the computer 200. Although the description of computer-readable media contained herein refers to a mass storage device, such as a hard disk or CD-ROM drive, it should be appreciated by those skilled in the art that computer-readable media can be any available media that can be accessed by the computer 200.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 200.

The computer 200 may connect to an external network through a network interface unit 206 connected to the bus 204. It should be appreciated that the network interface unit 206 may also be utilized to connect to other types of networks and remote computer systems. The computer 200 may also include an input/output controller 212 for receiving and processing input from a number of other devices, including a keyboard, mouse, or electronic stylus (not shown in FIG. 2). Similarly, an input/output controller may provide output to a display screen, a printer, or other type of output device (also not shown in FIG. 2).

The JAD planning software 222 may include an identification of participants wizard 231 that assists a user in identifying JAD session participants. The identification of participants wizard 231 may, for example, provide a user with user interface windows 80 and 90. The JAD planning software 222 may also include a JAD application directory 232 that stores a JAD session document 233. The JAD session document 233 identifies sessions and their respective durations and topics.

As mentioned briefly above, a number of program modules and data files may be stored in the mass storage device 210 and RAM 214 of the computer 200, including the operating system 220 suitable for controlling the operation of the computer 200. The mass storage device 210 and RAM 214 may also store one or more program modules. In particular, the mass storage device 210 and the RAM 214 may store JAD planning software 222 configured to enable a user to plan for and coordinate JAD sessions. For example, the JAD planning software may provide the user with the user interface windows depicted in FIGS. 1-9. The JAD planning software 222 may be configured to determine the duration, times, and/or dates for JAD sessions. The JAD planning software 222 may also be configured to generate invitation and reminder messages to be sent to JAD session participants. The JAD planning software 222 may also be configured to provide JAD session participants with information about upcoming and/or completed JAD sessions.

Other program modules may also be stored in the mass storage device 210 and utilized by the computer 200. For example, the mass storage device 210 may include e-mail software 224 configured to send and receive e-mails. The e-mail software 224 may interact with the JAD planning software 222 to enable a user to send e-mails to JAD session participants and/or participants. For example, the e-mail software may be configured to enable a user to send the e-mail message illustrated in FIG. 10 to JAD session participants.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims. Various modifications and changes may be made to the subject matter described herein without following the example embodiments and applications illustrated and described, and without departing from the true spirit and scope of the embodiments, which is set forth in the following claims.

What is claimed is:

1. A computer implemented method for planning a group of sessions, comprising:
receiving a plurality of session requirements;
receiving timing information corresponding to the group of sessions;
determining based on the plurality of session requirements and the timing information if the group of sessions is capable of being implemented;
providing a session schedule responsive to determining that the group of sessions is capable of being implemented; and
providing a notification that the group of sessions is not capable of being implemented responsive to determining that the group of sessions is not capable of being implemented based on the plurality of session requirements and the timing information.

2. The method of claim 1, further comprising:
generating a plurality of invitation messages configured to invite a plurality of participants to a session of the group of sessions; and
generating a plurality of reminder messages configured to remind the plurality of participants to attend the session of the group of sessions.

3. The method of claim 2, further comprising receiving from the plurality of participants a plurality of response messages that are responsive to the plurality of invitation messages.

4. The method of claim 2, further comprising receiving a user input designating at least one participant of the plurality of participants, wherein at least one of the plurality of invitation messages is sent to the at least one participant designated by the user input.

5. The method of claim 1, further comprising assigning a respective date to each of the sessions responsive to the plurality of session requirements and responsive to the timing information.

6. The method of claim 1, wherein the timing information comprises a target date for when the sessions are to be completed.

7. The method of claim 1 further comprising:
providing a user with suggested durations and topics corresponding to the sessions responsive to the plurality of session requirements.

8. The method of claim 7, further comprising:
receiving a second user input identifying at least one modification to the suggested durations and topics; and
modifying at least one of the suggested durations and topics responsive to the second user input.

9. The method of claim 8, wherein a date of at least one session of the group of sessions is responsive to the second user input.

10. The method of claim 1, wherein the sessions are joint application design sessions.

11. A system for planning a group of sessions, comprising:
a processor; and
memory that is coupled to the processor, the memory having instructions stored therein, the instructions being configured to enable the processor to:
receive a plurality of session requirements;
receive timing information corresponding to the group of sessions;
determine based on the plurality of session requirements and the timing information if the group of sessions is capable of being implemented;
provide a session schedule responsive to determining that the group of sessions is capable of being implemented; and
provide a notification that the group of sessions is not capable of being implemented responsive to determining that the group of sessions is not capable of being implemented based on the plurality of session requirements and the timing information.

12. The system of claim 11, wherein the instructions are further configured to enable the processor to:
generate a plurality of invitation messages configured to invite a plurality of participants to a session of the group of sessions; and
generate a plurality of reminder messages configured to remind the plurality of participants to attend the session of the group of sessions.

13. The system of claim 12, wherein the instructions are further configured to enable the processor to receive from the plurality of participants a plurality of response messages that are responsive to the plurality of invitation messages.

14. The system of claim 12, wherein the instructions are further configured to enable the processor to receive a user input designating at least one participant of the plurality of participants, wherein at least one of the plurality of invitation messages is sent to the at least one participant designated by the user input.

15. The system of claim 11, wherein the instructions are further configured to enable the processor to assign a respective date to each of the sessions responsive to the plurality of session requirements and responsive to the timing information.

16. A computer-readable storage medium comprising:
instructions configured to enable a computer to:
receive a plurality of session requirements;
receive timing information corresponding to the group of sessions;
determine based on the plurality of session requirements and the timing information if the group of sessions is capable of being implemented;
provide a session schedule responsive to determining that the group of sessions is capable of being implemented; and
provide a notification that the group of sessions is not capable of being implemented responsive to determining that the group of sessions is not capable of being implemented based on the plurality of session requirements and the timing information.

17. The computer-readable storage medium of claim 16, wherein the instructions are further configured to enable the computer to:
generate a plurality of invitation messages configured to invite a plurality of participants to a session of the group of sessions; and
generate a plurality of reminder messages configured to remind the plurality of participants to attend the session of the group of sessions.

18. The computer-readable storage medium of claim 17, wherein the instructions are further configured to enable the computer to receive from the plurality of participants a plurality of response messages that are responsive to the plurality of invitation messages.

19. The computer-readable storage medium of claim 17, wherein the instructions are further configured to enable the computer to receive a user input designating at least one participant of the plurality of participants, wherein at least one of the plurality of invitation messages is sent to the at least one participant designated by the user input.

20. The computer-readable storage medium of claim 16, wherein the instructions are further configured to enable the computer to assign a respective date to each of the sessions responsive to the plurality of session requirements and responsive to the timing information.
